(19) United States
(12) Patent Application Publication
(10) Pub. No.: US 2008/0104702 A1
(43) Pub. Date: May 1, 2008

(54) NETWORK-BASED INTERNET WORM DETECTION APPARATUS AND METHOD USING VULNERABILITY ANALYSIS AND ATTACK MODELING

(76) Inventors: Yang Seo CHOI, Daejeon (KR); Dae Won KIM, Daejeon (KR); Ik Kyun KIM, Daejeon (KR); Jin Tae OH, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/685,940

(22) Filed: Mar. 14, 2007

(30) Foreign Application Priority Data
Oct. 27, 2006 (KR) 10-2006-105179

(51) Int. Cl. G06F 11/00

(52) U.S. Cl. 726/23

(57) ABSTRACT

The present invention relates to a network-based Internet worm detection apparatus and method using vulnerability analysis and attack modeling. In the network-based Internet worm detection apparatus, a vulnerability information storage unit stores the vulnerability information of an application program that is necessary for attack detection. A threat determiner determines whether a packet transmitted over a network is destined for a vulnerable application program with vulnerability. A packet content extractor extracts, using the vulnerability information, information for determination of an attack packet from the packet determined to be destined for the vulnerable application program. An attack determiner compares and analyzes the extracted information and the vulnerability information to determine whether the packet is an attack packet. The vulnerability information of the application program and attack modeling are used to detect an Internet worm, thereby making it possible to counteract the attack packet. In addition, only a portion of information belonging to a specific session of a segmented or disordered packet is stored, thereby making it possible to increase the use efficiency of a storage device and to reduce the resource necessary for processing a packet.

### CLAIM OF PRIORITY

This application claims the benefit of Korean Patent Application No. 2006-105179 filed on Oct. 27, 2006 in the Korean Intellectual Property Office, the disclosure of which is incorporated herein by reference.

### TECHNICAL FIELD

The present invention relates to a network-based Internet worm detection apparatus and method, and more particularly, to a network-based Internet worm detection apparatus and method using vulnerability analysis and attack modeling, in which vulnerability information of the application program and attack modeling are used to detect an Internet worm, thereby making it possible to counteract the attack packet. In addition, the apparatus and method stores only a portion of information belonging to a specific session of a segmented or disordered packet, thereby making it possible to increase the use efficiency of a storage device and to reduce the resource necessary for processing a packet.

### BACKGROUND ART

In general, all Internet worms, which propagate at a high speed, are designed to be self-reproduced and to avoid an external interference during the propagation thereof, in order to provide the rapidity of the propagation thereof. That is, if an attacker produces and distributes one Internet worm at first, the Internet worm automatically performs self-reproduction and selection of an infection target.

The most vital act of the high-speed Internet worm is to automatically transmit its reproduced worm to a predetermined infection target so that the reproduced worm is executed automatically. A low-speed Internet worm propagates via e-mails. Such a low-speed Internet worm needs to be executed by a user itself so that it is executed in a target attack system. For example, because a user executes an e-mail file personally out of curiosity, the corresponding Internet worm is executed in the attack target system and attempts to perform additional infection.

However, the high-speed Internet worm attacks the vulnerability of an application program operating in a system to demodulate an instruction pointer of the application program, such that the Internet worm is executed automatically. Therefore, the high-speed Internet worm can perform self-reproduction and additional infection simultaneously with an attack operation without user intervention and additional control, and thus can propagate very rapidly. Such an Internet worm uses an attack technique such “buffer overflow” and “format string”.

In the buffer overflow attack technique, the buffer management drawbacks of an application program are used to insert a predetermined attack code into a memory and thus an return address of a specific function is changed into the storage location of the inserted attack code to move an instruction pointer to the inserted attack code, thereby executing a predetermined instruction or code. The most main feature of the buffer overflow attack technique is that a return address is recorded in a code that is inserted into a buffer vulnerable to an attack. In detail, the return address is hard-coded into the inserted code. The “hard-coding” refers to the same expression method as a method for expressing the return address in the memory, such as “Oxbffff32”. The destination of the return address is an attack code inserted by an attacker or the location of a predetermined library function for executing a random code capable of reading the inserted code as a factor.

The format string attack technique uses the drawbacks of the format of a programming language (e.g., C Language) used to develop an application program. An application program with format-string vulnerability uses format strings that are not detected in a general user input, and uses a combination of the format strings to insert a desired value at a desired location in a memory. The typical example of the format string attack technique is to use a format indicator “% n” to insert the number of predetermined characters at a predetermined location. Such a feature is very difficult to use for intrusion detection without an additional analysis. The reason for this is that it is impossible to determine, in a network, which range a memory address used for an actual attack belongs to.

### DISCLOSURE

### Technical Problem

Examples of the prior arts of the present invention are an intrusion detection system, an intrusion blocking system, and an intrusion prevention system. However, for detection of an attack, the prior arts use signatures for a plurality of possible attack type (e.g., an exploit code) related to specific vulnerability or blocks all packets that use a port number used by a vulnerable application program. If all the packets using the port number used by the vulnerable application program are blocked, all services provided using the vulnerable application become unavailable. The fundamental solution for the above problems is the use of a patch or update scheme. However, it takes a long time for a developer of an application program to detect vulnerability and to provide a patch or update program over the vulnerability. Accordingly, the application program cannot be used for a long time until the provision of the patch program.

### Technical Solution

The present invention has been made to solve the foregoing problems of the prior art and therefore an aspect of the present invention is to provide a network-based Internet worm detection apparatus and method using vulnerability analysis and attack modeling, which makes it possible to beforehand detect and counteract an Internet worm that is determined to be an attack packet.

Another aspect of the present invention is to provide a network-based Internet worm detection apparatus and method using vulnerability analysis and attack modeling, which stores and used only a portion of information belonging to a predetermined session of a segmented or disordered packet, thereby making it possible to increase the use efficiency of a storage device and to reduce the resource and time necessary for processing the segmented or disordered packet.

### Advantageous Effects

As set forth above, the network-based Internet worm detection apparatus and method according to the exemplary embodiments of the present invention extracts the information for the intrusion detection through the analysis of the vulnerability information of the application program, and extracts the attack packet for the corresponding vulnerability, thereby making it possible to detect and prevent the attack against the vulnerable application program.

In addition, the present invention stores only data within the range of the maximum keyword size among the entire information about the segmented or disordered packets, thereby making it possible to increase the efficiency of the storage unit and to reduce the resource and time that are required to process the segmented or disordered packets.

Moreover, the present invention stores and uses the session information and the vulnerability information of the application program, thereby making it possible to reduce the resource and time necessary for detection of an Internet worm and to efficiently detect an Internet worm that is propagated very fast over a network.

### DESCRIPTION OF DRAWINGS

The above and other objects, features and other advantages of the present invention will be more clearly understood from the following detailed description taken in conjunction with the accompanying drawings, in which:

FIG. 1 is a block diagram of a network-based Internet worm detection apparatus using vulnerability analysis and attack modeling according to an embodiment of the present invention;

FIG. 2 is a system diagram illustrating the application of an Internet worm detection apparatus to a network environment according to an embodiment of the present invention;

FIG. 3 is a flowchart illustrating a network-based Internet worm detection method according to an embodiment of the present invention; and

FIG. 4 is a conceptual diagram illustrating the information in a packet for packet segment management according to an embodiment of the present invention.

### BEST MODE

According to an aspect of the present invention, a network-based Internet worm detection apparatus include: a vulnerability information storage unit for storing the vulnerability information of an application program that is necessary for attack detection; a threat determiner for determining whether a packet transmitted over a network is destined for a vulnerable application program with vulnerability; a packet content extractor for extracting, using the vulnerability information, information for determination of an attack packet from the packet determined to be destined for the vulnerable application program; and an attack determiner for comparing/analyzing the extracted information and the vulnerability information to determine whether the packet is an attack packet.

According to another aspect of the present invention, a network-based Internet worm detection method includes: collecting, analyzing and storing the vulnerability information of an application program that is necessary for attack detection; collecting a packet transmitted/received over a network; determining whether the collected packet is destined for a vulnerable application program with vulnerability; extracting information for intrusion determination with respect to the packet transmitted to the vulnerable application program; comparing/analyzing the extracted packet information and the stored vulnerability information to determine whether the corresponding packet is an attack packet; and if the packet is determined to be an attack packet, outputting information of the packet to a manager or a security device or deleting the attack packet.

### Mode for Invention

Exemplary embodiments of the present invention will now be described in detail with reference to the accompanying drawings.

In the following description of the embodiments of the present invention, detailed descriptions about well-known functions and configurations incorporated herein will be omitted if they are deemed to obscure the subject matter of the present invention. In addition, like reference numerals in the drawings denote like elements.

The present invention extracts information for intrusion detection by analysis of a detected vulnerability. That is, the present invention detects an attack using an already-detected vulnerability. The detection of the vulnerability of an application program reveals “the kind of an operating system that operates the application program”, “the kind of a port used by the application program”, “a condition that causes the vulnerability”, and “the kind of the vulnerability”. That is, if the vulnerability of an application program is detected, it is possible to know in which case the application program has a problem. In this case, it is possible to analyze the condition for the problem by executing the operation program with the vulnerability in the same operating system before the occurrence of an actual attack. This makes it possible to beforehand detect an approximate location of data that can be stored in a memory through a corresponding buffer in a function with the buffer overflow vulnerability and an in-memory location of the main library function available during the attack.

In this respect, the important thing is to know “the kind of the vulnerability and the condition for the vulnerability”. Every application program has an application protocol for the availability thereof. That is, there is a protocol that must be followed to use a corresponding protocol remotely via a network. In an attack operation, an attacker accesses a target system remotely via a network in obedience to a protocol used by an application program of the target system and then inserts attack data into the application program using a predetermined keyword (i.e., a predetermined value or a predetermined character string contained in the application program). Examples of the predetermined keyword are GET and PUT in HTTP and SEND and RECV in SMTP. Accordingly, by analysis of an application program with vulnerability, it is possible to detect the maximum buffer size available for a predetermined keyword and a boundary marker (i.e., a data end indicator) used by the application program. Therefore, by vulnerability analysis, it is possible to detect the size of a vulnerable buffer and a keyword that must be used to transmit predetermined data to the vulnerable buffer. In case of a buffer overflow attack, the vulnerability analysis makes it possible to circumscribe the range of an estimate storage location of attack data (which is received via a network) in a system where a vulnerable application program is operated. Similarly, in case of a format string attack, the vulnerability analysis makes it possible to circumscribe the range of an estimate storage location of an attack address in data. That is, the characteristics of the buffer overflow attack technique and the format string attack technique can be used for intrusion detection.

For this reason, the present invention uses the following information (illustrated in Table 1 below) as vulnerability information for intrusion detection.

TABLE 1
information for intrusion detection

| | |
|---|---|
| 1 | A port number used by a vulnerable application |
| | program |
| 2 | A keyword used to attack the vulnerability |
| | of a vulnerable application program |
| 3 | The type of data transmitted using a vulnerable |
| | keyword (numerals, characters, binary data, etc.) |
| 4 | The size of a buffer on a memory where a user input |
| | is stored through a vulnerable keyword of |
| | a vulnerable application program |
| 5 | The range of an address used as a return address |
| 6 | A boundary maker used by a corresponding keyword |
| 7 | The possible start location of the |
| | corresponding keyword |
| 8 | etc. |

The vulnerability information is used to generate a signature for intrusion detection. The generated signature may be written in the format that can be distributed simultaneously with the detection of vulnerability. The use of the vulnerability information may be provided not only for the practical embodiment of the present invention but also in a way that can be applied to a variety of security systems such as a conventional intrusion detection system and a conventional intrusion prevention system.

In addition, the conditions of network packet segmentation and packet order change must be overcome in order to efficiently use the vulnerability information in a network-based intrusion detection system. The reason for this is that, if a network packet is segmented or the order of an arrival packet is changed, a corresponding keyword may fail to be detected due to keyword segmentation even when data are transmitted using the keyword.

In order to overcome the above problem, the present invention provides a more efficient technique than a conventional session information management technique used in an information protection system. The present invention provides an improved session information management technique that is more efficient than the conventional session information management and to be suitable for the present invention.

The object of session management in the present invention is to overcome the problematic case in which the keyword fails to be detected due to the packet segmentation and the packet order change. To this end, the present invention stores and manages only a keyword-detectable packet segment. That is, the present invention stores only a packet segment necessary for keyword detection, not the entire packet necessary for session management. The storage of only the packet segment for session management is more efficient than the storage of the entire packet. To this end, the present invention uses the value of “maximum keyword size”. The maximum keyword size refers to the size of the largest one of all keywords used in a vulnerable application program. The storage of only the necessary packet segment makes it possible to efficiently use a storage resource. Each application program may have its own header/tail portions, the related information of which is obtained through additional application program analysis in the vulnerability analysis and is stored as session management information, along with the above vulnerability information.

The present invention uses the following information (illustrated in Table 2) for session management.

TABLE 2
information for session management

| | |
|---|---|
| 1 | Source IP address |
| 2 | Destination IP address |
| 3 | Source port number |
| 4 | Destination port number |
| 5 | Network protocol information |
| 6 | Maximum keyword size |
| 7 | The first and last data of a predetermined packet |
| | corresponding to the maximum keyword size |
| 8 | Packet segmentation information |
| 9 | Packet order information |

Some application programs attempt to segments a packet at an application level using a predetermined keyword. In this case, it may be impossible to know whether only a packet IP and a TCP/UDP header are used to segment the packet. In order to overcome this problem, when a new session is generated, the present invention retains information for the session management until the termination of the session.

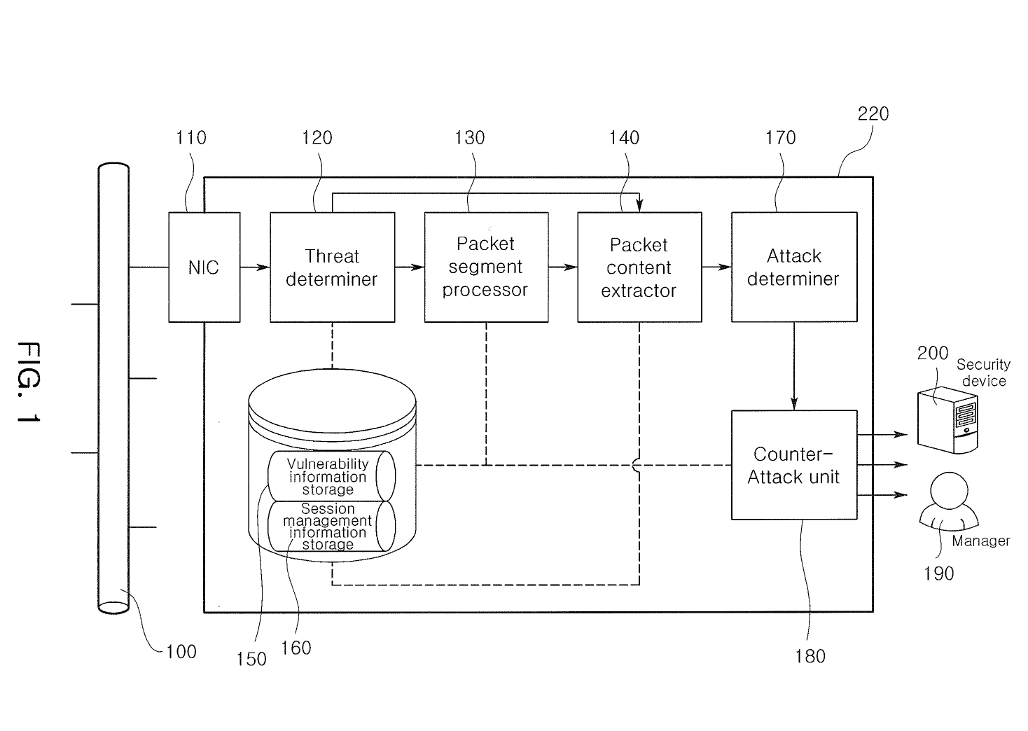

FIG. 1 is a block diagram of a network-based Internet worm detection apparatus using vulnerability analysis and attack modeling according to an embodiment of the present invention.

Referring to FIG. 1, a network-based Internet worm detection apparatus 220 includes a threat determiner 120, a packet content extractor 140, an attack determiner 170, and a vulnerability information storage unit 160.

In addition, the network-based Internet worm detection apparatus 220 may further include a packet segment processor 130, a session management information storage unit 160, a counter-attack unit 180, and a manager 190 or a security device 200.

A network interface card (NIC) unit 110 is an interface means for enabling the network-based Internet worm detection apparatus 220 to collect a packet from a network 100.

The threat determiner 120 collects a packet from the network 100, and determines whether the collected packet is destined for a vulnerable application program, using vulnerability information received from the vulnerability information storage unit 150. In detail, the threat determiner 120 determines whether the collected packet uses a port identical to a port used by the vulnerable application program. If the collected packet is destined for the vulnerable application program, the threat determiner 120 outputs the collected packet to the packet segment processor 130 or the packet content extractor 140. At this point, if the corresponding packet was received in the format of packet segments or with its order changed, the threat determiner 120 outputs the corresponding packet to the packet segment processor 130.

If the corresponding packet was received in the format of packet segments or with its order changed, the packet segment processor 130 combines the packet segments or corrects the changed order so that a keyword can be extracted from the corresponding packet.

The packet content extractor 140 extracts necessary information from the corresponding packet to determine whether the corresponding packet is an attack packet. Examples of the necessary information are a source IP address, a destination IP address, a used port number, network protocol information, the maximum keyword size necessary for keyword detection, and the first and last data of the corresponding packet corresponding to the maximum keyword size.

The attack determiner 170 compares the information extracted from the corresponding packet with the vulnerability information stored in the vulnerability information storage unit 150, to determine whether the corresponding packet is an attack packet. For example, information, such as whether a port used by the corresponding packet is identical to a port used by the vulnerable application program, whether the header and tail of the corresponding packet are identical to those of the vulnerable application program, and whether the data type and bounder pointer of the corresponding packet are identical to those generally used by the vulnerable application program, are compared/analyzed/weighted. If the total analysis result exceeds a predetermined threshold, the corresponding packet is determined to be an attack packet.

If the corresponding packet is determined to be an attack packet, the counter-attack unit 180 notifies the fact to the manager 190 or the security device 200, or deletes the corresponding packet.

In this process, the packet segment processor 130 and the attack determiner 170 stores session management information in the session management storage unit 160 so that the corresponding packet will be used in the same session to determine for attack determination and packet segment combination. Examples of the session management information are a source IP address, a destination IP address, a source port number, a destination port number, network protocol information, the maximum keyword size, the first and last data of the corresponding packet corresponding to the maximum keyword size, packet segmentation information, and packet order information.

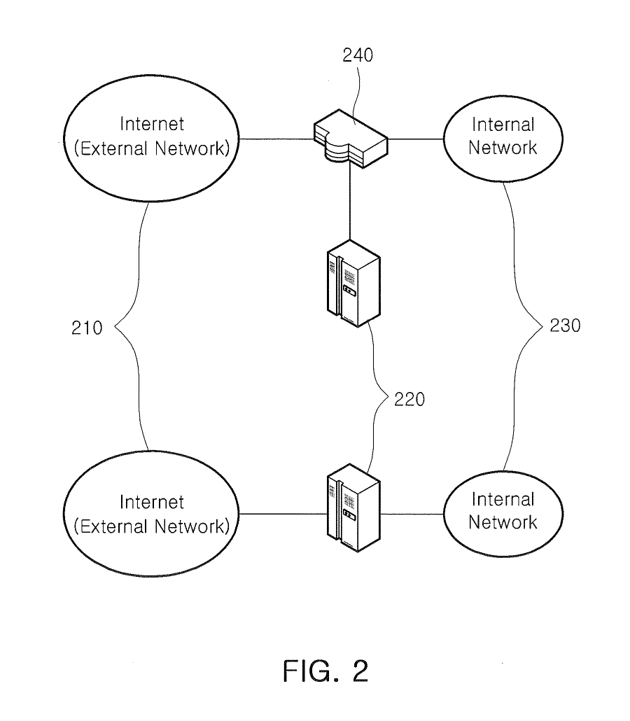

FIG. 2 is a system diagram illustrating the application of an Internet worm detection apparatus to a network environment according to an embodiment of the present invention.

The lower portion of FIG. 2 illustrates the case where an Internet worm detection apparatus 220 is implemented in an in-line mode between an external Internet network 210 and an internal network 230. The upper portion of FIG. 2 illustrates the case where the Internet worm detection apparatus 220 is implemented in a monitoring mode through a monitor 240 located between the external Internet network 210 and the internal network 230. In each of the in-line mode and the monitoring mode, if a packet is determined to be an attack packet, the Internet work detection apparatus may notify the attack packet to the manager or the security device, or may delete the attack packet.

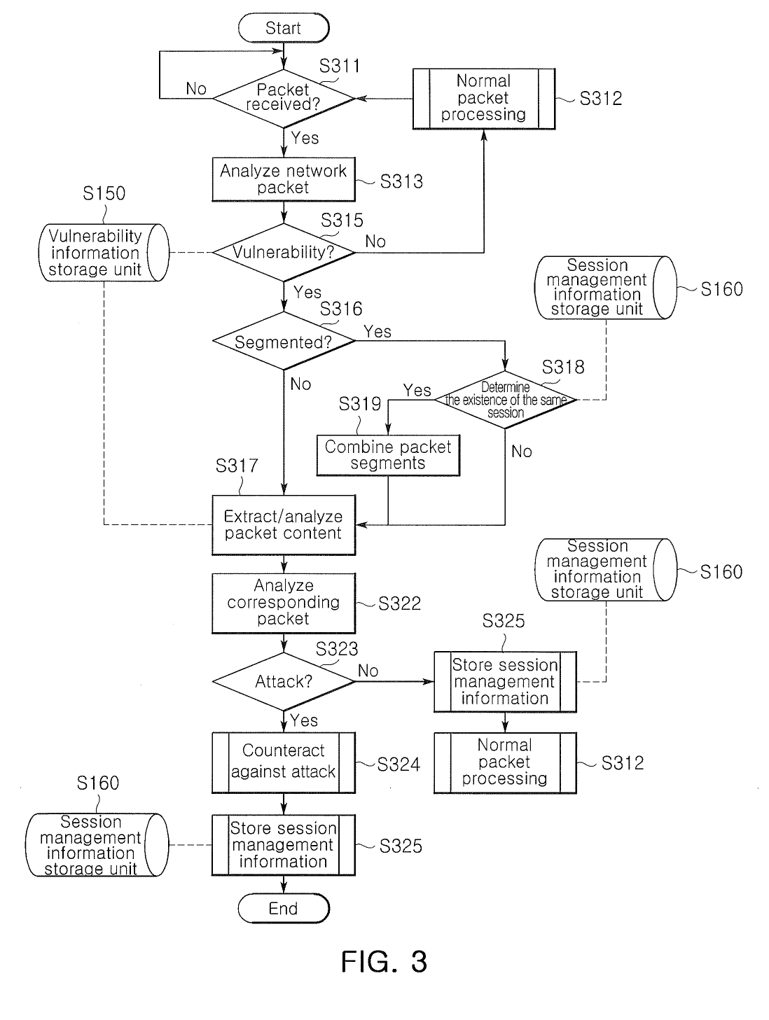

FIG. 3 is a flowchart illustrating a network-based Internet worm detection method according to an embodiment of the present invention.

Referring to FIG. 3, if a network packet is received from the network 100 through the NIC unit 110 (step S311), the attack determiner 120 analyzes the network packet to extract a used port number (step S313). In step S315, the attack determiner 120 compares the extracted port number with the vulnerability information of the vulnerability information storage unit 150 to determine whether an application program using a corresponding port has vulnerability. If the application program has no vulnerability, the network packet is processed in accordance with a normal packet process operation (step S312). On the other hand, if the application program has vulnerability, it is determined whether the network packet was received in the format of packet segments or with its order changed (step S316). If the network packet was not segmented, the attack determiner 120 outputs the corresponding packet to the packet content extractor 140. On the other hand, if the network packet was received with it order changed, the attack determiner 120 outputs the corresponding packet to the packet segment processor 130.

The normal packet process operation (step S312) may be performed in various ways. For example, if the Internet worm detection apparatus is implemented in the in-line mode illustrated FIG. 2, the network packet is forwarded normally. It will be apparent to those skilled in the art that the normal packet process operation (step S312) can be implemented in other ways.

If the network packet was received in the format of packet segments or with its order changed, the packet segment processor 130 analyzes the received packet to determine whether there is a previous packet that belongs to the same session as the corresponding packet (step S318). If there is a packet belonging to the same session as the corresponding packet, the previous packet of the corresponding session is used to combine a currently-receive packet in order (step S319). The step S319 is performed through packet header analysis in consideration of the order with respect to the previous packet, and the combined packet is output to the packet content extractor 140. On the other hand, if there is no packet belonging to the same session, the corresponding packet is output to the packet content extractor 140 as it is.

In step S317, the packet content extractor 140 extracts information for attack packet determination from the received packet and analyzes the extracted information. Because the locations and characteristics of available information are different depending on the type of the vulnerability of an application program, the corresponding vulnerability information is obtained from the vulnerability information storage unit 150 and necessary information is extracted on the basis of the obtained information. Examples of the extracted information are a source IP address, a destination IP address, a used port number, network protocol information, the maximum keyword size necessary for keyword detection, and the first and last data of the corresponding packet corresponding to the maximum keyword size. Thereafter, the packet content extractor 140 outputs the vulnerability information necessary for information extraction to the attack determiner 170. This is done to prevent a waist of resource that is caused when the same information is repeatedly accessed by a plurality of terminals at different places. In another embodiment of the present invention, the attack determiner 170 may directly obtain the vulnerability information from the vulnerability information storage unit 150, instead of receiving the vulnerability information from the packet content extractor 140.

On the basis of the packet information and the vulnerability information received from the packet content extractor 140, the attack determiner 170 determines whether the corresponding packet is an attack packet (step S322). At this point, the characteristics of an Internet worm and the characteristics of an attack technique are used to make the above determination. However, because there is a plurality of information elements available at the attack determiner 170, all information may not be accorded with respect to a specific packet. That is, some of criteria for attack determination may be accorded but the other criteria may not be accorded. In this case, after the used vulnerability information is assigned priority and weight, if the analysis result containing the weight exceeds a predetermined threshold, the corresponding packet is determined to be an attack packet. If not, the corresponding packet is determined to be a normal packet. If the corresponding packet is not an attack packet (step S323), the related information is stored in the session management information storage unit 160 for the subsequent additional analysis (step S325) and the corresponding packet is processed according to the normal packet process operation (step S312). On the other hand, if the corresponding packet is an attack packet (step S323), the determination results about the corresponding packet are output to the counter-attack unit 180.

When the corresponding packet is determined to be an attack packet, the counter-attack unit 180 outputs the corresponding results to the security device 200 to block the related packet or notifies the corresponding results to the manager 190 to support the counteraction of the manager 190 against the attack packet (step S324). Alternatively, the counter-attack unit 180 may delete the corresponding packet oneself. At this point, the session information on the attack packet is stored in the session management information storage unit 160 (step S325) and can be used in processing another packet.

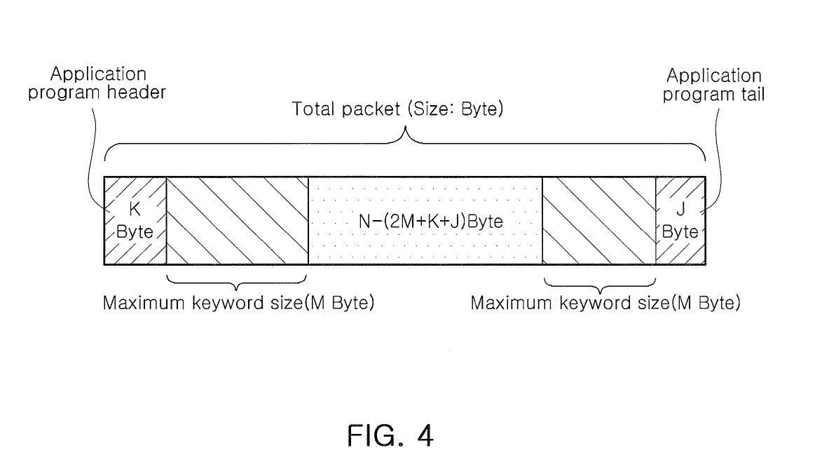

FIG. 4 is a conceptual diagram illustrating the information in a packet for packet segment management according to an embodiment of the present invention.

Referring to FIG. 4, in order to use the session management information storage unit 160 more efficiently, not the entire packet (N bytes) requiring ascertainment but only a packet segment ((M+M) bytes) necessary for attack detection is stored in the session management information storage unit 160. That is, instead of retaining the entire packet contents for session management, the present invention stores only the packet segment for keyword detection in the session management information storage unit 160. This can increase the use efficiency of the storage unit, when compared to a general method of storing the entire packet content.

To this end, the present invention uses the value of “maximum keyword size’. The maximum keyword size refers to the size of the largest one of all keywords used in a vulnerable application program. That is, not the entire packet requiring ascertainment but only the packet segment within the range of the maximum keyword size, which is necessary for attack detection, is stored in the session management information storage unit 160, thereby making it possible to efficiently use the storage resource. In addition, it is possible to reduce the resource or time that is necessary for an operation of reading/processing packet data. Moreover, it is possible to increase the efficiency in processing segmented packets or disordered packets and in using the previous session management information.

While the present invention has been shown and described in connection with the preferred embodiments, it will be apparent to those skilled in the art that modifications and variations can be made without departing from the spirit and scope of the invention as defined by the appended claims.

### INDUSTRIAL APPLICABILITY

The network-based Internet worm detection apparatus and method according to the exemplary embodiments of the present invention extracts the information for the intrusion detection through the analysis of the vulnerability information of the application program, and extracts the attack packet for the corresponding vulnerability, thereby making it possible to detect and prevent the attack against the vulnerable application program.

In addition, the present invention stores only data within the range of the maximum keyword size among the entire information about the segmented or disordered packets, thereby making it possible to increase the efficiency of the storage unit and to reduce the resource and time that are required to process the segmented or disordered packets.

Moreover, the present invention stores and uses the session information and the vulnerability information of the application program, thereby making it possible to reduce the resource and time necessary for detection of an Internet worm and to efficiently detect an Internet worm that is propagated very fast over a network.

1. A network-based Internet worm detection apparatus comprising:
a vulnerability information storage unit for storing the vulnerability information of an application program that is necessary for attack detection;
a threat determiner for determining whether a packet transmitted over a network is destined for a vulnerable application program with vulnerability;
a packet content extractor for extracting, using the vulnerability information, information for determination of an attack packet from the packet determined to be destined for the vulnerable application program; and
an attack determiner for comparing/analyzing the extracted information and the vulnerability information to determine whether the packet is an attack packet.

2. The network-based Internet worm detection apparatus according to claim 1, further comprising, if the packet destined for the vulnerable application program is segmented or disordered, a packet segment processor for combining the segmented information of the packet or correcting the order of the disordered packet before outputting information about the packet to the packet content extractor.

3. The network-based Internet worm detection apparatus according to claim 1, wherein the attack determiner assigns priority and weight to each vulnerable information compared and analyzed for attack detection and determines that the packet is an attack packet, if the total analysis result exceeds a predetermined threshold.

4. The network-based Internet worm detection apparatus according to claim 1, wherein the vulnerability information storage unit stores at least one of a port number used by the application program, a keyword used to attack the vulnerability, the type of data transmitted using the keyword, a boundary marker of the keyword, the start location of the keyword, and the range of a return address.

5. The network-based Internet worm detection apparatus according to claim 2, further comprising a session management information storage unit for storing one of s source IP address and a destination IP address of the corresponding packet, and a port number, network protocol information, data of a keyword, segmentation information, and order information received from the attack determiner, and providing the previous session management information and the previous packet information necessary for processing the segmented or disordered packet received from the packet segment processor.

6. The network-based Internet worm detection apparatus according to claim 5, further comprising a counter-attack unit for, if the packet analyzed by the attack determiner is determined to be not an attack packet, storing the information of the packet in the session management information storage unit, and, if the packet is an attack packet, outputting the information of the attack packet to a manager or a security device or deleting the attack packet.

7. The network-based Internet worm detection apparatus according to claim 5, wherein the session management information storage unit, if stores the data of a keyword, further stores only the maximum keyword size and the first and last data within the range of the maximum keyword size that is necessary for keyword detection.

8. A network-based Internet worm detection method comprising:
collecting, analyzing and storing the vulnerability information of an application program that is necessary for attack detection;
collecting a packet transmitted/received over a network;
determining whether the collected packet is destined for a vulnerable application program with vulnerability;
extracting information for intrusion determination with respect to the packet transmitted to the vulnerable application program;
comparing/analyzing the extracted packet information and the stored vulnerability information to determine whether the corresponding packet is an attack packet; and
if the packet is determined to be an attack packet, outputting information of the packet to a manager or a security device or deleting the attack packet.

9. The network-based Internet worm detection method according to claim 8, further comprising, if a packet destined for the vulnerable application is segmented or disordered, combining the segmented information elements of the packet or correcting the disorder of the packet on the basis of the previous session management information and the previous packet information before extraction of information for intrusion detection.

10. The network-based Internet worm detection method according to claim 8, wherein the step of determining whether the collected packet is an attack packet assigns priority and weight to vulnerability information for attack determination and determines the collected packet to be an attack pack only if the related comparison/analysis result exceeds a predetermined threshold.

11. The network-based Internet worm detection method according to claim 8, wherein the stored vulnerability information of the vulnerable application information is at least one of a port number used by the application program, a keyword used to attack the vulnerability, the type of data transmitted using the keyword, a boundary marker of the keyword, the size of a buffer on a memory in which an user input is stored using a vulnerable keyword of the vulnerable application information, the start location of the keyword, and the range of a return address.

12. The network-based Internet worm detection method according to claim 9, further comprising, in order to provide information used to combine the segmented information elements of the packet or to correct the disorder of the packet, storing s source IP address and a destination IP address of the collected packet, and a port number, network protocol information, data of a keyword, segmentation information, and order information.

13. The network-based Internet worm detection method according to claim 12, wherein the data of the keyword are only the maximum keyword size and the first and last data within the range of the maximum keyword size necessary for keyword detection.
